(19) United States
(12) Patent Application Publication
(10) Pub. No.: US 2003/0086694 A1
(43) Pub. Date: May 8, 2003

(54) Recording program scheduling information in an electronic calendar

(75) Inventor: Marcus Davidsson, Linkoping (SE)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 10/035,557

(22) Filed: Nov. 7, 2001

(51) Int. Cl. H04N 5/92; G06F 3/00; G06F 13/00

(52) U.S. Cl. 386/83; 725/58

(57) ABSTRACT

The present invention allows a person to add TV program information into an electronic calendar of a multimedia apparatus. A user accesses an electronic programming guide and selects a program of interest from the guide. The guide is stored either at a remote location, or locally after having been downloaded from a source. Upon selection of a TV program in the guide, an entry is then automatically entered into the user's electronic calendar at the appropriate day and time using the information from the guide corresponding to the selected TV program. The entry displayed can be the name of the selected program and the channel of its broadcast. At the time of the broadcast of the selected program, an indication may be displayed on the television as a reminder. The user may alternatively enter the appropriate G-code directly in the electronic calendar. The multimedia apparatus will then, in background and without interrupting the electronic calendar function, retrieve from the guide TV program information corresponding to the G-code.

### BACKGROUND OF THE INVENTION

1. Field of the Invention

The present invention relates generally to recording content in the electronic calendar of a multimedia apparatus for display on a screen and, more particularly, to an apparatus and method of inserting content from an electronic TV program guide into an electronic calendar of a multimedia apparatus.

2. Description of the Related Art

Currently, when a user wants to see a specific television program, the user manually tunes the TV to the desired channel at the appropriate time. Another method is to program a VCR to record the desired TV program which is then viewed at a later but more convenient time. Each process has its special problems. With the first, the viewer must make a mental note that he wants to see a specific program, and must then remember the specific day, time and channel number when the desired program will be played. To avoid missing the TV program, some viewers have resorted to using a memory aid such as the reminder function of a multimedia apparatus. The multimedia apparatus can be a personal computer (PC), a set-top box (STB), a cellular phone (CPH) or any other device capable of reviewing TV program listings and setting reminders. When using an electronic calendar, the viewer enters the program name and, in some instances, the channel number and the start time in the appropriate day box of the electronic calendar. If the day box of the calendar is divided into one-half hour or hour time slots, then the time that the program is to start can be eliminated (assuming that the program starts on the hour or on the half hour). Information about the day, date, time, channel number and duration of a TV program can be obtained directly from the TV guide of a newspaper or magazine, or from the television program guide transmitted by a satellite or cable TV system provider.

The TV program guide transmitted by the satellite or cable TV system provider is an electronic schedule grid which displays a list of programs and the broadcast time and channel number for each program. The listings are normally in a common format of a grid where each column of the grid represents a specific broadcast time slot and each row represents a particular channel number. The program names are at the intersections of the rows and columns. The grid may be stepped or continuously scrolled vertically on the screen to allow a viewer to see a continuously refreshed group of programs. The screen may be a TV or computer screen, the display of a cellular phone or any other screen capable of displaying TV program listings. The TV program guides that appear in publications such as newspapers and in television program magazines may use the grid format to list the various TV programs, or they may list the various TV programs in a one channel per column format.

For each TV program listed by the satellite and cable TV system providers and the newspapers and TV magazines, a code is typically also listed. This code is known as the G-code. It contains specific information about the various TV programs such as channel number, starting time and duration, title and possibly other information which may be the names of the actors and actresses and whether closed caption and stereo are available. In some instances, a brief description of the program may be provided. The G-code is presently used to program a VCR and a TV set to select and record a specific television program. As described in U.S. Pat. No. 5,307,173, a decoding means which can decode the G-codes of the electronic programming guide is embedded within a television set. When the G-codes are entered, the decoder decodes the codes into channel, date, time and length information which is used to program a VCR or a television set to receive a selected TV program.

As disclosed in U.S. Pat. No. 6,025,837, an electronic programming guide in combination with hyperlinks is used to tune a TV set. More specifically, a user interface unit employs an operating system which supports drag-and-drop functionality. While reviewing available programs in the electronic programming guide (EPG), the viewer drags a particular program or channel label from its location within the EPG and a user interface unit, and drops the label at another location on the TV screen. The operating system associates the drag-and-dropped label to tune the TV set to the program or channel represented by the particular label.

U.S. Pat. No. 5,692,214 discloses the use of a PC to assist in the selection of TV programs. Future programming schedule information is provided to the PC from a remote database and displayed on the monitor of the PC under control of a database program which allows chronological, alphabetical or topical selection. In addition, the operator may move a cursor on the display screen to point to a particular program to select it for future recording. A remote transmitter connected to the PC output port can send signals to the VCR at the time the selection is made to allow future unattended programming memory of a video recorder to initiate the recording of a specific channel.

Each of these methods is advantageous in controlling a television receiver. However, rather than simplifying the process of reminding a person when a particular TV program will be broadcast, each adds further complexity to the selection process or addresses the programming problem.

### SUMMARY OF THE INVENTION

The present invention solves the above noted problem by allowing a person or family to install TV program information in the electronic calendar of a multimedia apparatus in the same way that ordinary every day events of a general nature such as “have lunch with Marcus” or “call Acme Ltd. about delivery” would be installed. The TV information inserted into the electronic calendar acts as a reminder for the user(s) to watch or record a desired TV program. With this invention, when a person is interested in watching a specific TV program at 20:00 hours, he or she enters the electronic calendar of his multimedia apparatus and invokes the electronic programming guide by clicking the cursor on a TV icon or by clicking an electronic programming guide button on the remote control. Clicking on the icon or the button brings up the electronic schedule grid which contains the electronic programming guide transmitted by a satellite or cable TV service provider or by other means. The viewer now browses through the electronic programming guide until the desired TV program is identified. When the viewer clicks the cursor on the identified TV program, selective information such as the TV program name is transferred to the appropriate location of the electronic calendar of the multimedia apparatus. The electronic schedule grid is now replaced by the electronic calendar on the screen. If desired, other specific information about the TV program, such as channel number, length of program, etc. can also be transferred to and displayed in the electronic calendar.

The G code is the name given to the compressed code which contains the encoded CDTL (channel, date, time and length) information of the various TV Programs. In those instances where the G-code number of a program is known to the user from the TV schedule published in a newspaper or TV magazine, the user may input the G-code number while in the electronic calendar, and the name of the TV program, in addition to any other available and/or desired information, will be automatically recorded in the electronic calendar. There are two methods of using a known G-code number. In the first method, the user enters the G-code while in the electronic calendar and the G-code entered is used to insert the CDTL information derived from the G-code into the electronic calendar. In the second method, the user enters the G-code while in the electronic calendar and the entered G-code is used to retrieve TV program data from the electronic programming guide by parsing the database for an event with a corresponding G-code. In another embodiment, the user enters the desired channel at the appropriate time slot in the electronic calendar and, optionally, information about the TV program that is to be aired at that time on that channel is retrieved from the electronic programming guide and inserted in the electronic calendar.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 illustrates a flow diagram according to one embodiment of the present invention;

FIG. 2 is a view of the screen of a multimedia apparatus illustrating meetings, reminders and TV programs installed in an electronic calendar by different members of a family in accordance with the present invention;

FIG. 3 is an illustration of a possible visual display which may be used to designate that a conflict exists between at least two selected programs; and

FIG. 4 is a block diagram of structure in accordance with the present invention.

### DETAILED DESCRIPTION OF THE PRESENTLY PREFERRED EMBODIMENTS

Normally, when a person desires to watch a TV program at some future time and is concerned about forgetting to watch, he may go to a multimedia apparatus and bring up the electronic calendar used to record every-day events of a general nature. Typical entries in the calendar may be, for example, “lunch with Marcus” on the 12.00 time line; “meeting with David” on the 14.30 time line; and written across a bottom time line of the day is the reminder note “watch TV program on autos tonight”. In some instances, if more detailed information is known about the TV program, it may be more positively identified by listing the starting time and, possibly, the channel number. Clearly, if the specifics about the TV program such as program time and/or channel number are not known, then this information can be obtained from a newspaper or magazine TV program guide when the viewer goes home.

In accordance with the present invention, when a reminder message is to be entered into the electronic calendar of a multimedia apparatus which relates to an upcoming TV program, the user moves the cursor to a TV icon in the calendar display. Alternatively, there may be a electronic program guide button on the remote control. When the user clicks on the icon, the system software temporarily replaces the electronic calendar display, or opens up a separate window on the monitor of the multimedia apparatus, with the electronic programming guide. The process of temporarily entering the Electronic Programming Guide is similar to inserting an image into a Word document by invoking an image software program, selecting a desired image, and then returning to the document in the Word program. Now, by having the electronic programming guide displayed on the monitor, the guide can be browsed until the desired TV program is located and selected. Selection of the desired TV program automatically transfers and inserts the name of the TV program into the electronic calendar. The selected program now appears as a normal calendar event in the electronic calendar similar to the entries of “dinner with Tomas” and “go to the movies with . . . ”. The calendar event recorded for the TV program in the electronic calendar of the multimedia apparatus is not the same as a recording or reminder in an Electronic Programming Guide. Although a single program can be selected, alternatively a block of programs can be selected in one action. For example, if the user want to add entries into the electronic calendar for all of the TV programs on channel 4 from 21:00 hours to 23:00 hours, the user can select in the electronic programming guide all of these programs in one action. In addition, by the use of appropriate keys on the input device, the user can select more than one program in the electronic programming guide on different channels in one calendar entry action.

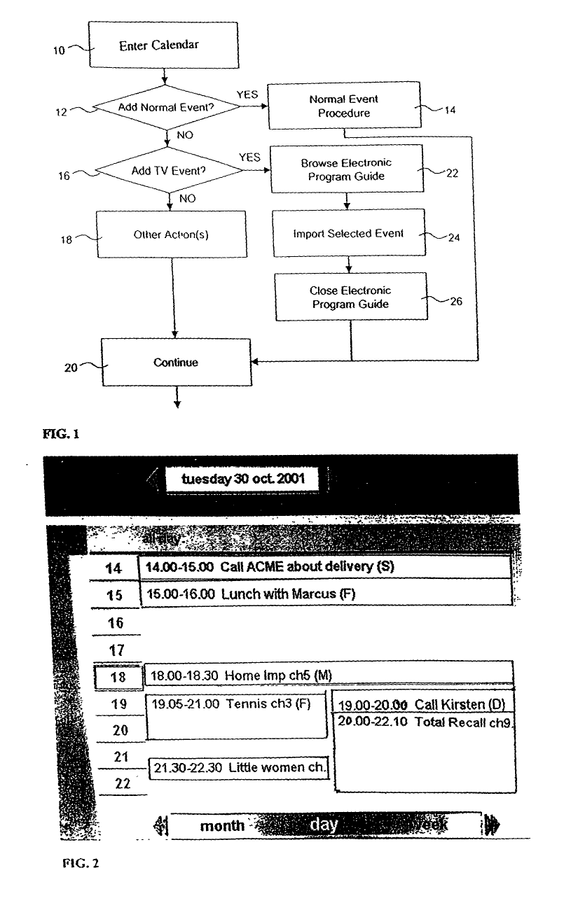

FIG. 1, is a flow chart for transferring events obtained from the Electronic Programming Guide to an electronic calendar in a multimedia apparatus in accordance with the present invention. In step 10, the multimedia apparatus is active and the electronic calendar is brought up and displayed on the monitor. At step 12, a determination is made as to whether or not a general nature event is to be added into the electronic calendar. If a general nature event is to be added into the electronic calendar the program advances to step 14 and the general nature event procedure for adding such calendar events into the electronic calendar is followed. If, at step 16, a determination is made that an event of a specific nature such as a TV event is to be added into the electronic calendar, then the program advances to step 22. If a TV event is not to be added, the program advances to step 18 where other appropriate action is taken and then proceeds to step 20. Such other action might include deleting or editing a calendar entry. Returning to step 16, if the determination is made that a TV event is to be added, which can be ascertained e.g. when the cursor is clicked on a TV icon of the display, the program advances to step 22 where the electronic programming guide replaces the electronic calendar (or is opened in a separate window) and is brought up on the monitor of the multimedia apparatus. The electronic programming guide is provided by the satellite or cable TV system provider or other provider or service through a programming connection, through a modem, and/or through an internet connection and is a display of the various programs of the current day and subsequent days, typically in a grid format. The electronic programming guide may be stored remotely and accessed as needed or may alternatively be periodically downloaded and stored in the multimedia apparatus. The electronic programming guide contains the name, time, duration and channel number of the various programs. The electronic programming guide typically also contains the G-code information for each TV program. The user of the multimedia apparatus scans or browses the electronic programming guide, identifies a desired program and selects the program by clicking the cursor on it. Scanning the electronic programming guide can be accomplished by using an input device, such as a mouse or keyboard arrow keys, to navigate up and down in the guide to go forward and backward in time, or left and right in the guide to see listings for different channels. Alternatively, an input device such as a keyboard, can be used to enter one or more keywords or alpha-numeric codes to search the guide for a particular program, such as entering “Tennis” to locate the listing for “Tennis ch3” as shown in FIG. 2. When the user selects a TV program, information about the selected TV program is imported from the electronic programming guide into the electronic calendar, step 24. For example, the information about the program channel, date, time, and length may be taken directly from the electronic programming guide. The electronic program guide is closed, step 26, and the electronic calendar is displayed on the monitor.

When a TV program entry has been added to the electronic calendar, the calendar contains the name of the TV program and may also contain one or more of the following: the starting time, the duration and/or the channel number. This information appears in the specific day area of the electronic calendar that the TV program is scheduled to be broadcast along with other general nature day reminder events such as “lunch with Marcus”, “meeting with David” and/or “call ACME Co. about delivery”. At step 20, the display returns to the electronic calendar for further use.

FIG. 2 is an electronic calendar illustrating nine hours of a day of calendar events in accordance with the present invention. Depending on user preference, the electronic calendar can show events for a single user, but it is preferably divided between several users within a family. The calendar starts with the entry that the “son” (S) is to call ACME about a delivery between 14:00 and 15:00. Thereafter, “father” (F) is to have lunch with Marcus between 15:00 and 16:00. The electronic calendar, in addition to displaying the normal every day events, also displays, as calendar events, TV programs that the multimedia apparatus user and members of his/her family have selected. As illustrated in FIG. 2, at time line 18, there is an entry that “mother” (M) has selected the TV program “Home Improvement” which starts at 18:00, ends at 18:30 and is on TV Channel 5. At time line 19, “father” has selected the program “Tennis” which starts at 19:05 and ends at 21:00 and is on Channel 3. Also at time line 19, “daughter” (D) has entered that she should call Kirsten between 19.00 and 20.00. At time line 20, there is an entry for “Total Recall” on channel 9 which runs from 20.00 to 22.10. The last entry in the calendar is on time line 21 and is for “Little Women” which runs from 21:30 to 22:30. For the “Total Recall” and “Little Women” entries, the display of the calendar shown in FIG. 2 does not display the person who made the entry, and the “Little Women” entry does not show the TV channel of that broadcast. The entirety of these two entries, including the channel number and the user identity may be displayed by selecting the entry and/or expanding the entry's window width. The electronic calendar shows that there is a time conflict between the two TV shows “Tennis” and “Total Recall” from 20:00 to 21:00. Although the schedule is shown in FIG. 2 with a 24 hour calendar, alternately a 12 hour (A.M./P.M.) calendar may be used.

In FIG. 2, the TV listings in the electronic calendar of events for the day display the name of the program selected, the person making the selection, the time and duration of the program selected and the channel number. If desired, one or more of these identifiers may be omitted and/or additional information can be displayed about each TV program selected.

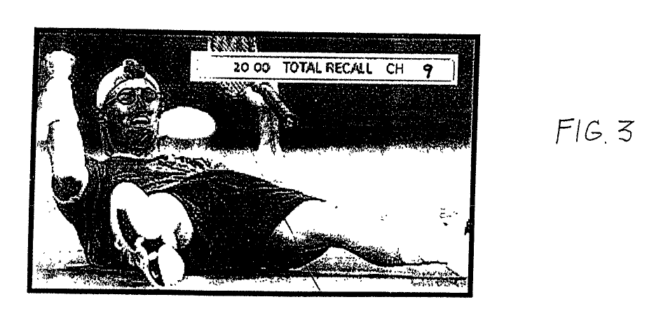

During the evening the TV set may be tuned to different channels irrespective of the contents in the electronic calendar. The user may check the electronic programming guide for information on broadcast programs or turn to the electronic calendar to see if any family member has plans for the evening. If the family in the example of FIG. 2 were using the electronic program guide only, then, referring to the schedule shown in FIG. 2, at 20:00 or shortly before that time, while “Tennis” is being watched by “father” on TV channel 3, a warning text message would appear on the television screen, such, for example, as illustrated in FIG. 3, indicating that it is now time to watch “Total Recall” on Channel 9. At this point, there may occur a heated debate between “father” and “son” over which channel to watch. Further, the warning can come too late for either “father” or “son” to locate a video cassette onto which a program can be recorded. However, if the invention had been used, such a conflict could have been discovered and solved anytime during the early afternoon of the same day or even of any preceding day.

The present invention enables a person, while arranging personal events in an electronic calendar, to temporarily move into a television programming guide to record, as a calendar event, the time of a TV program. In one exemplary use, a person has just finished watching the first episode of a TV program that consists of two episodes. To remind himself to watch the second episode, the person enters his electronic calendar and invokes the electronic program guide to browse and select the second episode. Selection of the TV program puts one or more identifiers of the TV program, such as the name of the program, and/or the time and channel number of the program, into the electronic calendar as a calendar event similar to the entry of a regular calendar event such as “lunch with Marcus”. Further, the person may easily spot conflicts in desired TV programming between different members of a household.

Optionally, the electronic calendar may be linked to the electronic programming guide in order to indicate, by way of an icon or a flag displayed in the electronic calendar, TV programming that has been tagged for reminder or recording in the electronic programming guide.

In accordance with the present invention, the G-code for a specific TV program can also be entered by the user using an input device and is used by the multimedia device to enable the calendar to enter that appropriate entry at the appropriate location for the TV program. There are two methods of using a known G-code number. In the first method, the user enters the G-code while in the electronic calendar and the G-code entered is used to insert the CDTL (channel, date, time and length) information derived from the G-code into the electronic calendar. In the second method, the user enters the G-code while in the electronic calendar and the entered G-code is used to retrieve data from the electronic programming guide by parsing the database for an event with a corresponding G-code. In another embodiment, the user enters the desired channel at the appropriate time slot in the electronic calendar and, optionally, information about the TV program that is to be aired at that time on that channel is retrieved and inserted in the electronic calendar.

When the G-code is not directly entered (either automatically from the program guide or manually by the user), a user may alternately enter into the electronic calendar a particular TV channel number in the appropriate time slot whereupon the electronic program guide is accessed to add the name of the program, or similar information to the calendar entry.

In another application of the invention, a person learns about an interesting TV program from a received e-mail message. Provided that the e-mail message is in a predetermined format or attaches a document in the predetermined format, the electronic calendar function can create and display a new TV event using the information obtained from the e-mail message. The electronic calendar may further access the electronic programming guide to retrieve the title of the TV program and any other information for insertion into the electronic calendar.

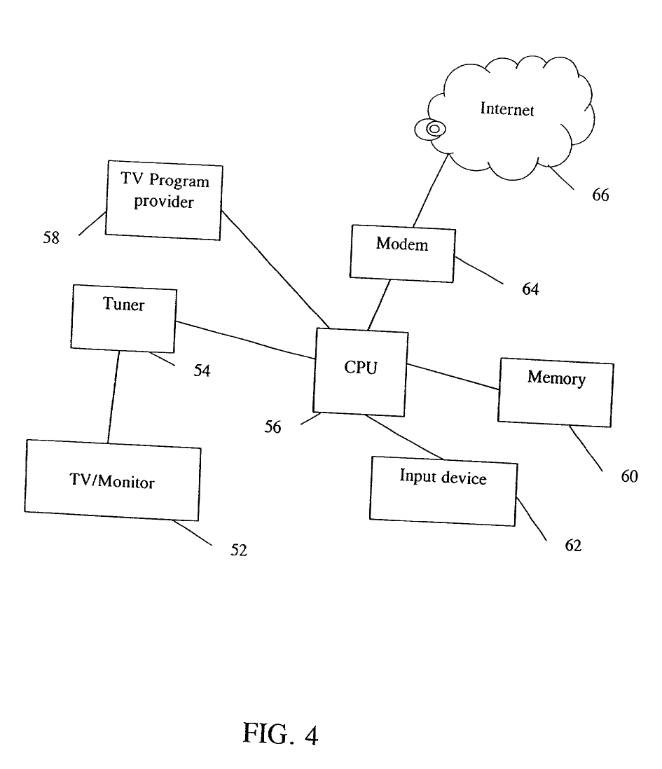

FIG. 4 is a block diagram of an exemplary device for implementing the present invention. Television programming is displayed on TV/monitor 52 which receives its TV programming signal from a tuner or set-top box 54. The tuner may be connected to a central processing unit (CPU) 56 which in turn is connected to a TV program provider 58, or alternatively, the tuner may be connected directly to the TV program provider 58. The connection to the TV program provider is a wired connection, such as by coaxial cable, a wireless connection, such as by satellite, or a combination of both. The TV program provider 58 provides the TV programs and may also provide a television programming guide. The CPU 56 may be a multimedia apparatus such as a personal or laptop computer, or a dedicated set-top box with more limited data processing capabilities than a computer. Connected to the CPU 56 is a memory device 60 in which various programs, databases and other information are stored. Among the items stored in memory 60 are the user's electronic calendar entries and programs to manipulate the calendar entries. An input device 62, such as a keyboard, a computer mouse pointing device, a remote controller and/or a microphone (for entering voice commands), is also connected to the CPU 56, with a wired or wireless connection. Preferably, a modem 64 is also connected to the CPU 56 so as to give access to the internet 66, or so that the CPU 56 may connect to the TV program provider 58 through a telephone connection. Although TV/monitor 52 is shown as one device having the capabilities of acting as a television and a monitor for multimedia apparatus such as a computer (CPU 56), alternatively, two separate display devices may be employed.

In operation, the TV 52 operates as a standard television, receiving its television programming signal through tuner 54 from the TV program provider 58, with operation of the TV 52 and/or tuner 54 being controlled by an input device 62, such as a standard remote control device. When a user wants to add a television program entry into his electronic calendar, the user activates the input device 62 accordingly, which instructs the CPU 56 and memory 60 to access the electronic calendar program and its data entries. A television programming guide is accessed by the CPU 56 either directly from the TV program provider 58, or indirectly through the modem 64 which obtains the television programming guide either from the TV program provider or elsewhere, or from an internet web site. The television programming guide may be always resident at a remote location (e.g., at TV program provider 58 or on the internet 66) and accessed as required to make appropriate entries into the electronic calendar, or alternatively, the television programming guide may reside locally in memory 60, by periodically downloading the guide from an appropriate source, and accessed locally as required. The user then manipulates entries in the calendar and the TV programming guide to add the desired entries to the electronic calendar, as discussed above, which entries are then stored in memory 60 for later use. At the appropriate time, the stored calendar entries for the selected TV programs are accessed by the CPU 54 to cause the television 52 to display the appropriate TV program reminder messages.

Although the present invention has been described with reference to scheduled programs broadcast and shown on a television, alternatively, the invention can be used to add annotations to an electronic calendar for scheduled video and audio programs that are broadcast over the internet, or for scheduled broadcast radio programs.

Thus, while there have been shown and described and pointed out fundamental novel features of the present invention as applied to preferred embodiments thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A method for entering information relating to a scheduled broadcast program into an electronic calendar comprising:
accessing an electronic calendar capable of storing a plurality of events at a plurality of times;
displaying the accessed electronic calendar on an electronic display;
accessing an electronic programming guide, the electronic programming guide listing a plurality of scheduled broadcast programs, and comprising information associated with each of the plurality of scheduled broadcast programs;
displaying the accessed electronic programming guide on the electronic display; and
selecting at least one of the plurality of scheduled broadcast programs in the accessed electronic programming guide, and thereby transferring information, associated with the at least one selected broadcast program, from the electronic programming guide to the accessed electronic calendar as at least one new entry, each new entry containing the information for a corresponding selected program and being stored in the electronic calendar at a time corresponding to a broadcast time of the respective at least one selected broadcast program.

2. The method of claim 1, wherein at least a portion of the displayed electronic calendar is replaced on the display by the electronic programming guide when the electronic program guide is accessed, and the electronic programming guide is removed from the display upon selection of the at least one of the plurality of broadcast programs.

3. The method of claim 1, wherein the scheduled broadcast programs listed in the electronic programming guide are television programs.

4. The method of claim 3, wherein the information transferred from the electronic programming guide to the electronic calendar comprises at least one of a name, start time, duration, and channel number of the corresponding at least one selected television program.

5. The method of claim 1, wherein the information transferred comprises an identification of the at least one selected broadcast program.

6. The method of claim 1, further comprising displaying one of a reminder and recording icon in the electronic calendar when a broadcast program for which an entry has been stored in the electronic calendar is tagged for one of a reminder and a recording function, respectively.

7. The method of claim 6, wherein the broadcast program for which an entry has been stored in the electronic calendar is tagged in the electronic programming guide for one of a reminder and a recording function, respectively.

8. The method of claim 1, wherein the step of selecting at least one of the plurality of scheduled broadcast programs in the accessed electronic programming guide comprises entering a code for a selected program, the code uniquely identifying the selected program.

9. The method of claim 1, wherein the step of selecting at least one of the plurality of scheduled broadcast programs in the accessed electronic programming guide comprises highlighting a listing in the accessed electronic programming guide corresponding to the at least one selected program.

10. A method for entering information relating to a scheduled broadcast program into an electronic calendar comprising:
accessing an electronic calendar capable of storing a plurality of events at a plurality of times;
displaying the accessed electronic calendar on an electronic display;
entering a code for a selected broadcast program, the code uniquely identifying the selected program; and
processing the entered code to determine information associated with the selected broadcast program; and
transferring the information to the accessed electronic calendar as a new entry containing the information for the selected program and being stored in the electronic calendar at a time corresponding to a broadcast time of the selected broadcast program.

11. The method of claim 10, wherein the selected broadcast program is a television program.

12. The method of claim 10, wherein the information transferred to the electronic calendar comprises at least one of a name, start time, duration, and channel number of the corresponding at least one selected television program.

13. The method of claim 10, further comprising displaying one of a reminder and recording icon in the electronic calendar when a broadcast program for which an entry has been stored in the electronic calendar is tagged for one of a reminder and a recording function, respectively.

14. The method of claim 13, wherein the broadcast program for which an entry has been stored in the electronic calendar is tagged in the electronic programming guide for one of a reminder and a recording function, respectively.

15. A multimedia device for entering information relating to a scheduled broadcast program into an electronic calendar comprising:
a data storage device in which is stored an electronic calendar capable of storing a plurality of events at a plurality of times
a first accessing means for accessing the electronic calendar stored in said data storage device;
a second accessing means for accessing an electronic programming guide listing a plurality of scheduled broadcast programs, the electronic programming guide comprising information associated with each of the plurality of scheduled broadcast programs; and
a processor coupled to said first and second accessing means and said data storage device, said processor capable, upon receipt of a control signal, of selecting at least one scheduled program in the accessed electronic programming guide, and thereby transferring information associated with the at least one selected broadcast program from the electronic programming guide to the accessed electronic calendar as at least one new entry, the at least one new entry containing the information for a corresponding selected program and being stored in the electronic calendar stored in said data storage device at a time corresponding to a broadcast time of the at least one selected broadcast program.

16. The multimedia device of claim 15, further comprising output means for generating a video output signal capable of driving a monitor, the video output signal being capable of displaying on the monitor the electronic calendar and the electronic programming guide.

17. The multimedia device of claim 16, wherein the video output signal is such that at least a portion of the electronic calendar when displayed is replaced by the electronic programming guide when the electronic programming guide is accessed, and the electronic programming guide when displayed is removed upon selection of a broadcast program.

18. The multimedia device of claim 15, wherein the scheduled broadcast programs listed in the electronic programming guide are television programs.

19. The multimedia device of claim 18, wherein the information transferred from the electronic programming guide to the electronic calendar comprises at least one of a name, start time, duration, and channel number of the selected television program.

20. The multimedia device of claim 15, wherein the information transferred comprises an identification of the at least selected broadcast program.

21. The multimedia device of claim 15, wherein said processor is capable of displaying one of a reminder icon and a recording icon in the electronic calendar when a broadcast program for which an entry has been stored in the electronic calendar is tagged for one of a reminder and a recording function, respectively.

22. The method of claim 21, wherein the broadcast program for which an entry has been stored in the electronic calendar is tagged in the electronic programming guide for one of a reminder and a recording function, respectively.

23. The multimedia device of claim 15, wherein the selecting at least one of the plurality of scheduled broadcast programs in the accessed electronic programming guide comprises processing an entered code to ascertain a broadcast program uniquely corresponding to the entered code.

24. The multimedia device of claim 15, wherein the selecting at least one of the plurality of scheduled broadcast programs in the accessed electronic programming guide comprises highlighting a listing in the accessed electronic programming guide corresponding to the at least one selected program.

25. A multimedia device for entering information relating to a scheduled broadcast program into an electronic calendar comprising:
a data storage device in which is stored an electronic calendar capable of storing a plurality of events at a plurality of times
a first accessing means for accessing the electronic calendar stored in said data storage device;
a code receiving means for receiving a code, the code uniquely identifying a selected scheduled broadcast program; and
a processor coupled to said first accessing means, said code receiving means, and said data storage device, said processor capable, upon receipt of the code, of processing the received code to determine information associated with the selected broadcast program, and, transferring the information to the accessed electronic calendar as a new entry containing the information for the selected program and being stored in the electronic calendar stored in said data storage device at a time corresponding to a broadcast time of the selected broadcast program.

26. The multimedia device of claim 25, wherein the selected broadcast program is a television program.

27. The multimedia device of claim 25, wherein the information transferred to the electronic calendar comprises at least one of a name, start time, duration, and channel number of the corresponding at least one selected television program.

28. The multimedia device of claim 25, wherein said processor is capable of displaying one of a reminder signal and a recording icon in the electronic calendar when a broadcast program for which an entry has been stored in the electronic calendar is tagged for one of a reminder and a recording function, respectively.

29. The method of claim 28, wherein the broadcast program for which an entry has been stored in the electronic calendar is tagged in the electronic programming guide for one of a reminder and a recording function, respectively.
